(19) United States
(12) Patent Application Publication
(10) Pub. No.: US 2002/0113687 A1
(43) Pub. Date: Aug. 22, 2002

(54) Method of extending image-based face recognition systems to utilize multi-view image sequences and audio information

(76) Inventors: Julian L. Center JR., Andover, MA (US); Christopher R. Wren, Cambridge, MA (US); Sumit Basu, Cambridge, MA (US)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 10/012,100

(22) Filed: Nov. 13, 2001

Related U.S. Application Data
(60) Provisional application No. 60/245,144, filed on Nov. 3, 2000.

(51) Int. Cl. H04Q 1/00

(52) U.S. Cl. 340/5.82; 340/5.83; 340/5.84; 382/118; 704/273

(57) ABSTRACT

A biometric identification method of identifying a person combines facial identification steps with audio identification steps. In order to reduce vulnerability of a recognition system to deception using photographs or even three-dimensional masks or replicas, the system uses a sequence of images to verify that lips and chin are moving as a predetermined sequence of sounds are uttered by a person who desires to be identified. In order to compensate for variations in speed of making the utterance, a dynamic time warping algorithm is used to normalize length of the input utterance to match the length of a model utterance previously stored for the person. In order to prevent deception based on two-dimensional images, preferably two cameras pointed in different directions are used for facial recognition.

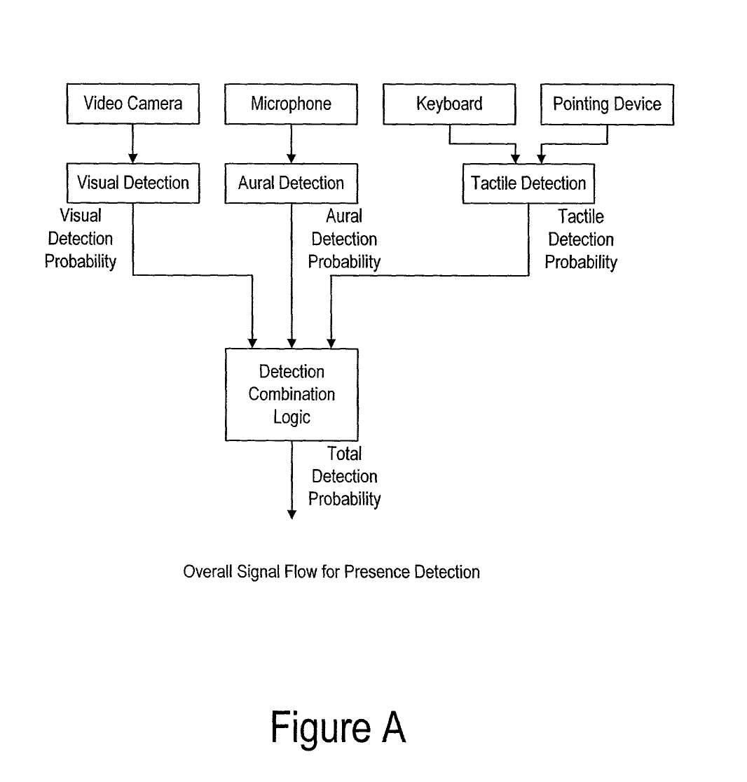

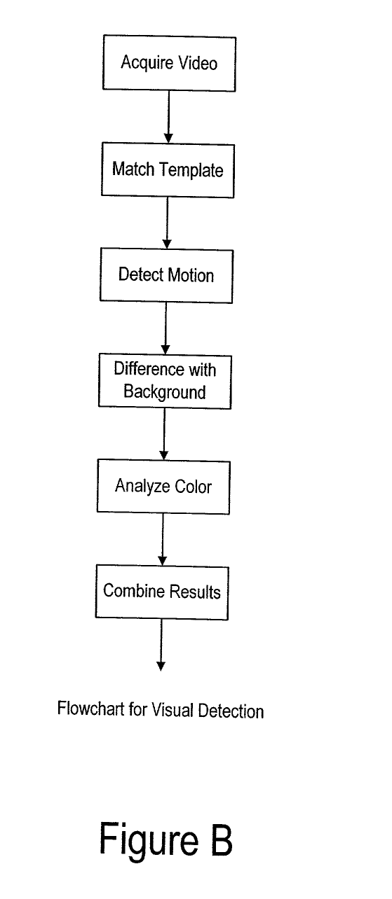

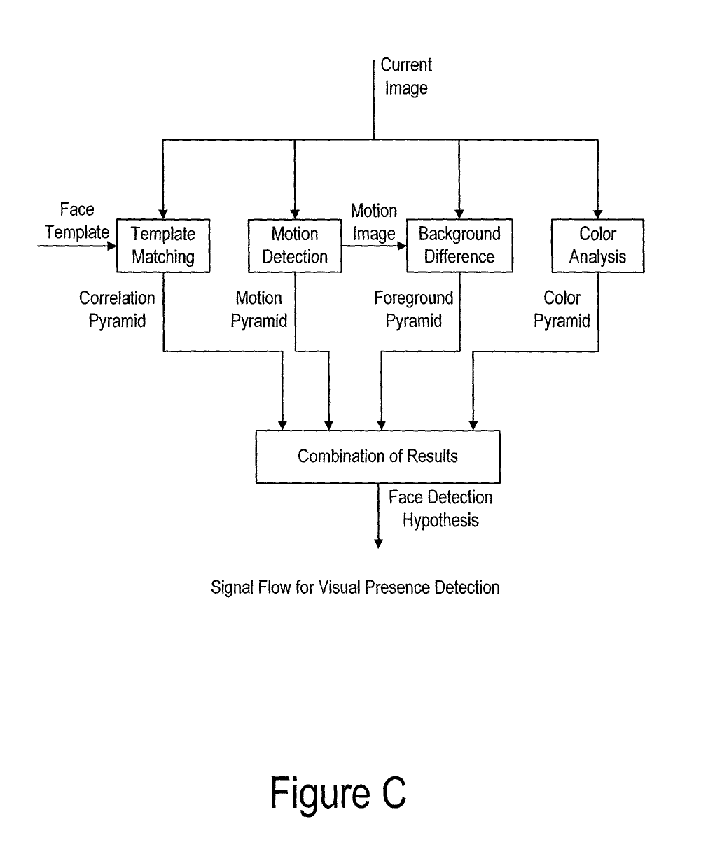

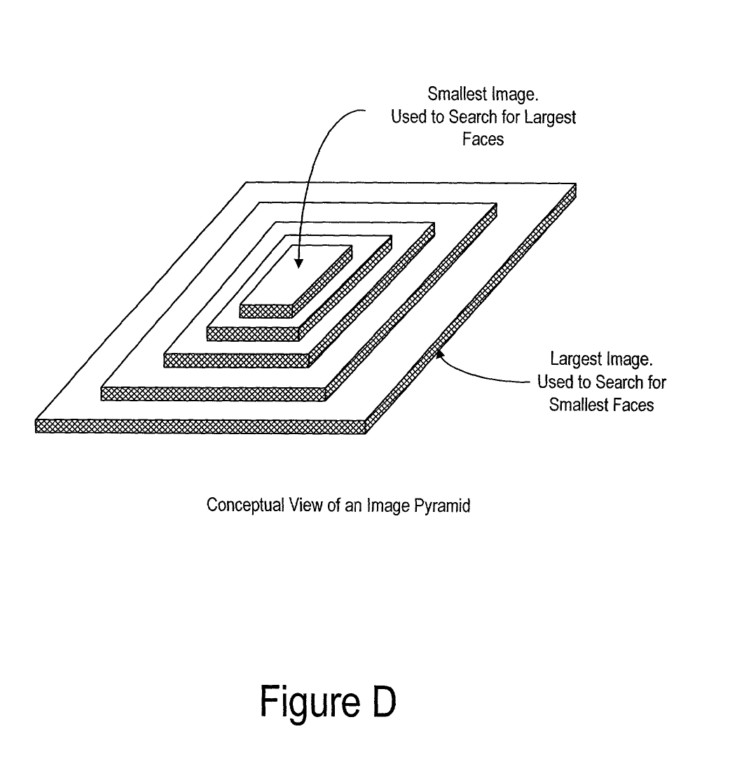

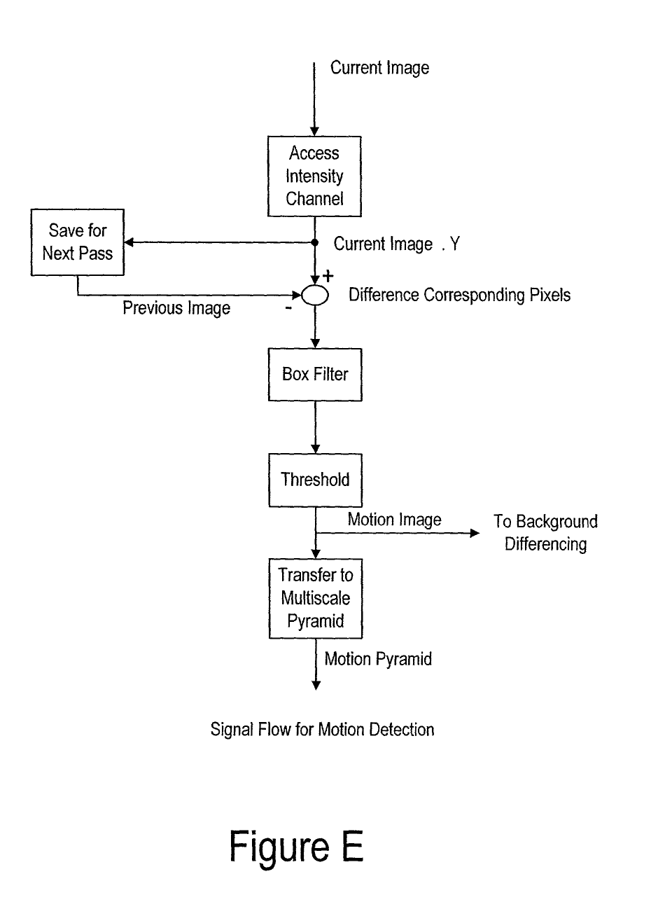

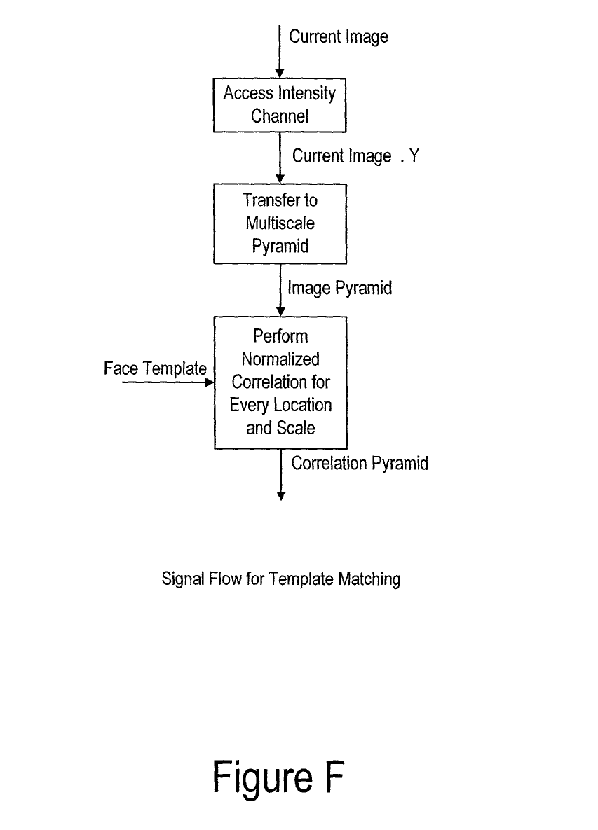

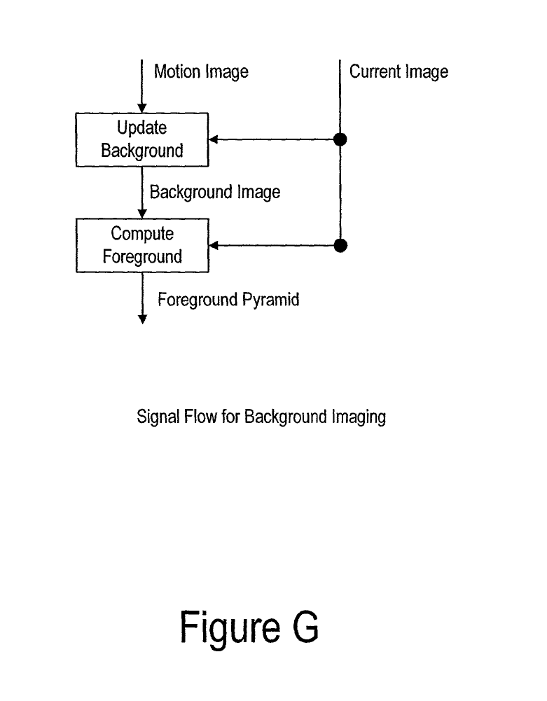

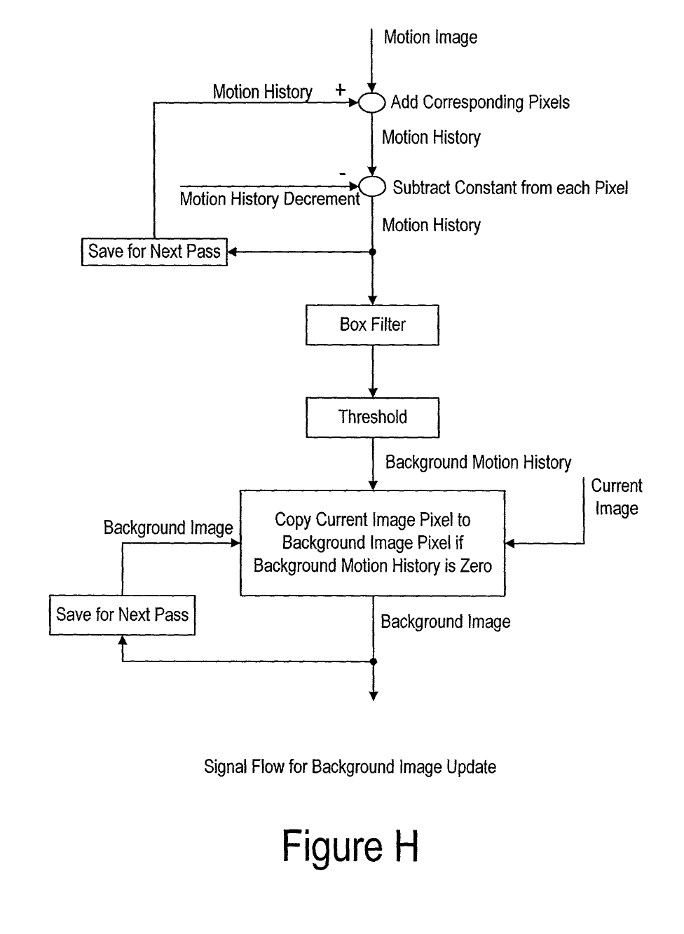

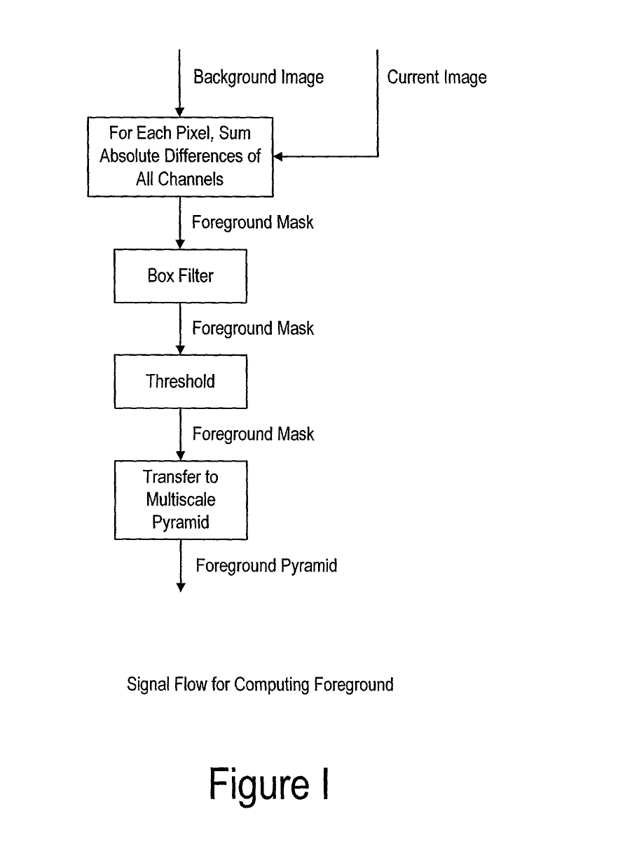

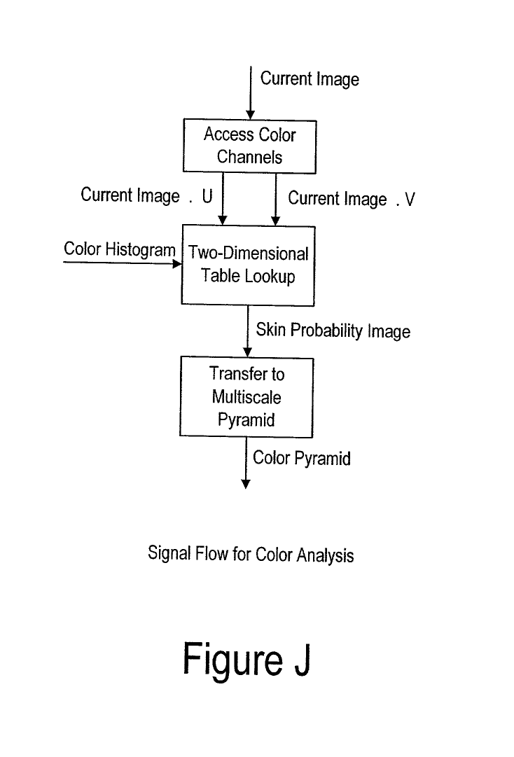

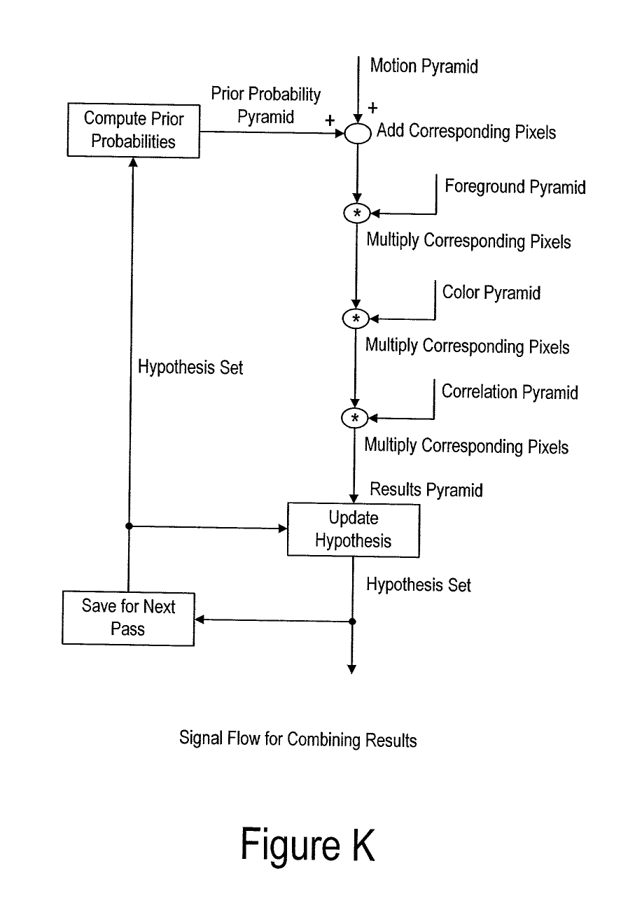

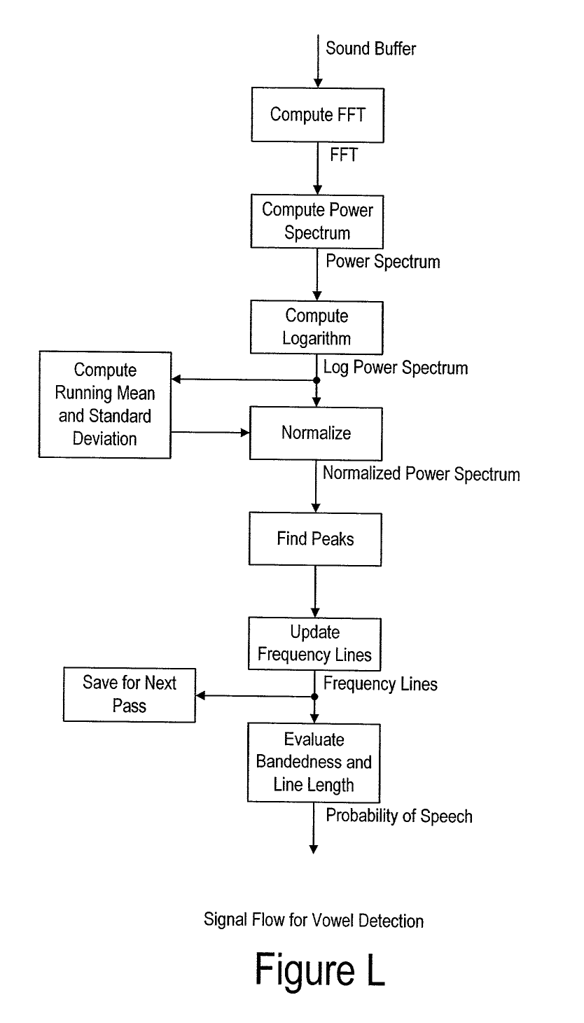

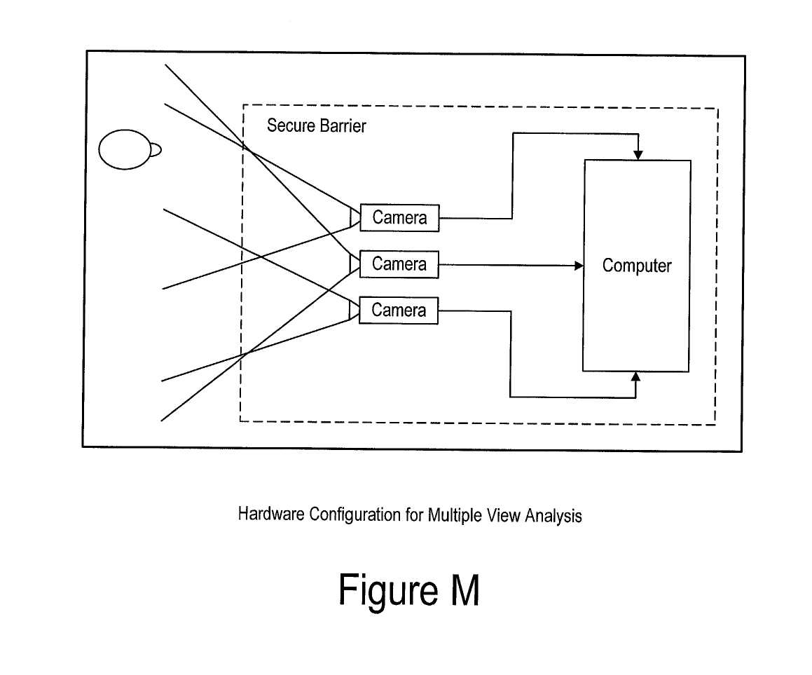

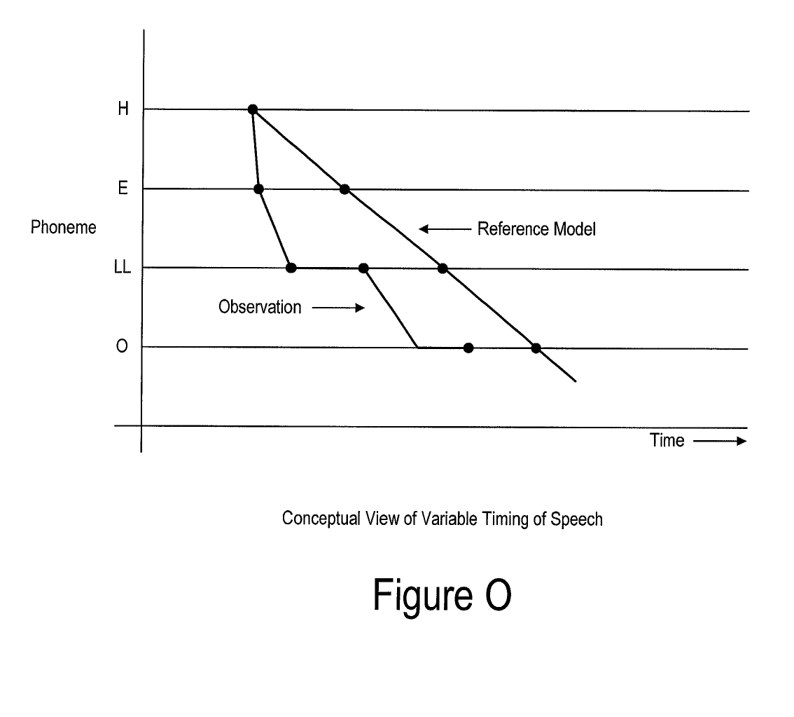

### CROSS-REFERENCE TO RELATED APPLICATION

This non-provisional application claims the benefit of our provisional application Ser. No. 60/245,144, filed Nov. 10, 2000.

### FIELD OF THE INVENTION

The present invention relates generally to methods of identifying specific persons and, more specifically to an improved identification method using more than one kind of data.

### BACKGROUND

Identity recognition using facial images is a common biometric identification technique. This technique has many applications for access control and computer interface personalization. Several companies currently service this market, including products for desktop person computers (e.g. Visionics FACE-IT; see corresponding U.S. Pat. No. 6,111,517).

Current face recognition systems compare images from a video camera against a template model which represents the appearance of an image of the desired user. This model may be a literal template image, a representation based on a parameterization of a relevant vector space (e.g. eigenfaces), or it may be based on a neural net representation. An “eigenface” as defined in U.S. Reissue Patent 36,041 (col. 1, lines 44-59) is a face image which is represented as a set of eigenvectors, i.e. the value of each pixel is represented by a vector along a corresponding axis or dimension. These systems may be fooled with an exact photograph of the intended user, since they are based on comparing static patterns. Such vulnerability to deception is undesirable in a recognition system, which is often used to substitute for a conventional lock, since such vulnerability may permit access to valuable property or stored information by criminals, saboteurs or other unauthorized persons. Unauthorized access to stored information may compromise the privacy of individuals or organizations. Unauthorized changes in stored information may permit fraud, defamation or other improper treatment of individuals or organizations to whom the stored information relates.

### SUMMARY OF THE INVENTION

Accordingly, there is a need for a recognition system which will (A) reliably reject unauthorized persons and (B) reliably grant access by authorized individuals. We have developed methods for non-invasive recognition of faces which cannot be fooled by static photographs or even sculpted replicas. That is, we can verify that the face is three-dimensional without touching it. We use rich biometric features which include both multi-view sequential observations coupled with audio recordings.

We have designed a method for extending an existing face recognition system to process multi-view image sequences, and multimedia information. Multi-view image sequences capture the time-varying three-dimensional structure of a user's face, by observing the image of the user as projected on multiple cameras which are registered with respect to each other, that is, their respective spacings and any differences in orientation are known.

### BRIEF FIGURE DESCRIPTION

FIGS. A-O are diagrams illustrating the features of the invention.

### DETAILED DESCRIPTION

Given an existing face recognition algorithm, which can be called as a function that returns a score function that a given image is from a particular individual, we construct an extended algorithm. A number of suitable face recognition algorithms are known. We denote the static face recognition algorithm output on a particular image based on a particular face model with S(M|I). Our extended algorithm includes the following attributes

1. The ability to process information across time.

2. The ability to merge information from multiple views.

3. The ability to use registered audio information.

We will review each of these in turn.

### SEQUENCE PROCESSING

Rather than analyze a single static image, our system observes the user over time, perhaps as they utter their name or a specific pass phrase. To detect that a person has entered a room, we use methods described in Wren, C., Azarbayejani, A., Darrell, T., Pentland A., “Pfinder: Real-time Tracking of the Human Body”, IEEE Transactions PAMI 19(7): 780-785, July 1997, and in Grimson, W. E. L., Stauffer, C., Romano, R., Lee, L. “Using adaptive tracking to classify and monitor activities in a site”, Proceedings of the IEEE Conference on Computer Vision and Pattern Recognition, Santa Barbara, Calif., 1998. Once presence of a person has been detected, a particular individual is identified, preferably using a method described in H. Rowley, S. Baluja, and T. Kanade, “Rotation Invariant Neural Network-Based Face Detection,” Proceedings of IEEE Conference on Computer Vision and Pattern Recognition, June, 1998. Alternatively, one could use techniques described U.S. Reissue Patent 36,041, M. Turk & A. Pentland, or in K.-K. Sung and T. Poggio, “Example-based Learning for View-based Human Face Detection,” AI Memo 1521/CBCL Paper 112, Massachusetts Institute of Technology, Cambridge, Mass., December 1994. To detect whether the person's lips and chin are moving, one can used methods described in N. Oliver, A. Pentland, F. Berard, “LAFTER: Lips and face real time tracker,” Proceedings of the Conference on Computer Vision and Pattern Recognition, 1997.

The stored model and observed image sequence are defined over time. The recognition task becomes the determination of the score that the entire sequence of observations I(O . . n) is due to a particular individual with model M(o.m).

The underlying image face recognition system must already handle variation in the static image, such as size and position normalization.

In addition to image information, the present invention includes a microphone which detects whether persons are speaking within audio range of the detection system. The invention uses a method which discriminates speech from music and background noise, based on the work presented in Schrier, E., and Slaney, M., “Construction and Evaluation of a Robust Multifeature Speech/Music Discriminator”, Proceedings of the 1997 International Conference on Computer Vision, Workshop on Integrating Speech and Image Understanding, Corfu, Greece, 1999.

Our extension to the prior art recognition method handles variations that may be present in a sampling rate, or in a rate of production of the utterance to be recognized. The utterance could be a password, a pass phrase, or even singing of a predetermined sequence of musical notes. Preferably, the recognition algorithm is sufficiently flexible to recognize a person even if the person's voice changes due to a respiratory infection, or a different choice of octave for singing the notes. Essentially, the utterance may be any predetermined sequence of sounds which are characteristic of the person to be identified.

If the sequence length of the model and the observation are the same (n==m), then this is a simple matter of directly integrating the computed score at each time point:

S(M(o . . . m)|I(O . . . n))=Sum S(M(i)|I(i) for i−O . . . n

When the sequence length of the observation and model differ, then we need to normalize for their proper alignment. FIG. O shows a conceptual view of the variable timing of a speech utterance. This is a classical problem in analysis of sequential information, and Dynamic Programming techniques can be easily applied. We use the Dynamic Time Warping algorithm, which produces an optimal alignment of the two sequences given a distance function. (See, for example, “Speech Recognition by Dynamic Time Warping”, http://www.dcs.shef.ac.uk/˜stu/com326/.) The static face recognition method provides the inverse of this distance. Denoting the optimal alignment of observation j as o(j), our sequence score becomes:

S(M(O . . . m)|I(O . . . n))=Sum S(M(o(j),u)|I(j,u)) for j=O . . . m, for u=O . . . v

This method can be directly applied in cases where explicitly delimited sequences are provided to the recognition system. This would be the case, for example, if the user were prompted to recite a particular utterance, and to pause before and after. The period of quiescence in both image motion and the audio track can be used to segment the incoming video into the segmented sequence used in the above algorithm.

### MULTIPLE VIEW ANALYSIS AND IMPLICIT SHAPE MODELING

Recognition of three dimensional shape is a significant way to prevent photographs or video monitors from fooling a recognition system. One approach is to use a direct estimation of shape, perhaps using a laser range finding system, or a dense stereo reconstruction algorithm. The former technique is expensive and cumbersome, while the latter technique is often prone to erroneous results due to image ambiguities.

Three dimensional shape can be represented implicitly, using the set of images of as object as observed from multiple canonical viewpoints. This is accomplished by using more than one camera to view the subject simultaneously from different angles (FIG. M). We can avoid the cost and complexity of explicit three dimensional recovery, and simply use our two dimensional static recognition algorithm on each view.

For this approach to work, we must assume that the user's face is presented at a given location. The relative orientation between each camera and the face must be the same when the model is acquired (recorded) and when a new user is presented.

When this assumption is valid, we simply integrate the score of each view to compute the overall score:

S(M(O . . . m,O . . . v),A(u . . . m)|I(O . . . n,O . . . v), U(O . . . n)=Sum S(M(O(J),u)|w(Ij,u))) for j=O . . . m, for u=O . . . v+Sum t(a(o(j))|U(j))for j=O . . . m.

With this, recognition is performed using three-dimensional, time-varying, audiovisual information. It is highly unlikely this system can be fooled by an stored signal, short of a full robotic face simulation or real-time holographic video display.

### THE CONVEX VIEW ASSUMPTION

There is one assumption required for the above conclusion: that the object viewed by the multiple camera views is in fact viewed simultaneously from multiple cameras. If the object is actually a set of video displays placed in front of each camera, then the system could easily be faked. To prevent such deception, a secure region of empty space must be provided, so that at least two cameras have an overlapping field of view despite any exterior object configuration. Typically this would be ensured with a box with a clear front enclosing at least one pair of cameras pointed in different directions. Geometrically, this would ensure that the subject being imaged is a minimum distance away and is three-dimensional, not separate two-dimensional photographs, one in front of each camera.

Various changes and modifications are possible within the scope of the inventive concept, as those in the biometric identification art will understand. Accordingly, the invention is not limited to the specific methods and devices described above, but rather is defined by the following claims.

### REFERENCES

S. Birchfield. “Elliptical head tracking using intensity gradients and color histograms,” Proceedings of the IEEE Conference on Computer Vision and Pattern Recognition, Santa Barbara, 1998.

Grimson, W. E. L., Stauffer, C., Romano, R., Lee, L. “Using adaptive tracking to classify and monitor activities in a site”, Proceedings of the IEEE Conference on Computer Vision and Pattern Recognition, Santa Barbara, 1998.

N. Oliver, A. Pentland, F. Berard, “LAFTER: Lips and face real time tracker,” Proceedings of the IEEE Conference on Computer Vision and Pattern Recognition, 1997.

Y. Raja, S. J. McKenna, S. Gong, “Tracking and segmenting people in varying lighting conditions using colour.” Proc. Int'l. Conf. Automatic Face and Gesture Recognition, 1998.

H. Rowley, S. Baluja, and T. Kanade, “Rotation Invariant Neural Network-Based Face Detection,” Proceedings of IEEE Conference on Computer Vision and Pattern Recognition, June, 1998.

Tom Rikert and Mike Jones and Paul Viola, “A Cluster-Based Statistical Model for Object Detection,” Proceedings of the International Conference on Computer Vision, 1999.

Schrier, E., and Slaney, M. “Construction and Evaluation of a Robust Multifeature Speech/Music Discriminator”, Proc. 1997 Intl. Conf. on Computer Vision, Workshop on Integrating Speech and Image Understanding, Corfu, Greece, 1999.

K.-K. Sung and t. Poggio, “Example-based Learning for View-based Human Face Detection” AI Memo 1521/CBCL Paper 112, Massachusetts Institute of Technology, Cambridge, Mass., December 1994.

Wren, C., Azarbayejani, A., Darrell, T., Pentland A., “Pfinder: Real-time tracking of the human body”, IEEE Trans. PAMI 19(7): 780-785, July 1997.

What is claimed is:

1. A method of automatically recognizing a person as matching previously stored information about that person, comprising the steps of:
detecting and recording a sequence of visual images and a sequence of audio signals, generated by at least one camera and at least one microphone, while said person utters a predetermined sequence of sounds;
normalizing duration of said recorded visual images and audio signals to match a duration of a previously stored model of utterance of said predetermined sequence of sounds; and
comparing said normalized recorded sequences with said previously stored model and determining whether or not said normalized recorded sequences match said model, to within predetermined tolerances.
